(19) United States
(12) Patent Application Publication
(10) Pub. No.: US 2005/0008889 A1
(43) Pub. Date: Jan. 13, 2005

(54) Notch shaping method, metallic mold for lens shaping, lens, and method of producing a lens

(76) Inventors: Kenichi Hayashi, Suwa-gun (JP); Yuji Fujita, Suwa-gun (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/850,413

(22) Filed: May 19, 2004

(30) Foreign Application Priority Data
May 20, 2003 (JP) 2003-141600

(51) Int. Cl. B32B 3/10

(52) U.S. Cl. 428/596; 65/374.12; 428/409

(57) ABSTRACT

The present invention provides a method of shaping notches for use in lens manufacturing including providing a material to be milled to form a curved surface having many concentric notches utilizing a bite. The flat type bite has rakes with a curvature radius of at most 0.1 μm at both ends of the flat cutting edge. The relative rotation of the bite and the material allows the flat type bite to mill the material in a desired shape as the cutting edge of the flat type bite is pressed against the material. The lens is milled by the flat portion along the cutting edge of the flat type bite in such a manner that the curved surface maintains an approximately linear shape and the notches are milled by the rakes on the cutting edge of the flat type bite. The present invention also provides a metallic mold for molding lens using the method of shaping notches, a method of manufacturing a lens and a lens having a surface with a curvature that has many concentric notches.

### CROSS-REFERENCES TO RELATED APPLICATIONS

This application claims priority of Japanese Application No. 2003-141600 filed on May 20, 2003, the complete disclosure of which are hereby incorporated by reference.

### TECHNICAL FIELD OF THE INVENTION

The present invention relates to a method of molding notches of diffraction gratings required for manufacturing lenses having a refracting surface of diffraction gratings. It also relates to a metallic mold for lens formation utilizing the above method of molding notches. It further relates to a lens and a method of manufacturing the lens.

### BACKGROUND OF THE INVENTION

There is a type of lens in which diffraction gratings having microscopic concentric notches are provided on the refracting surface thereof. This lens is capable of taking laser beams of two different wavelengths into diffraction gratings to emit diffracted beams to efficiently focus on CDs and DVDs with little aberrations even though CDs and DVDs are coated with a protective layer of different thicknesses and have different recording density. For example, Japanese unexamined patent publication No. 2000-81566 applies the lens type to an optical head apparatus which reproduces data from and records data on CDs and DVDs.

Usually, to mold the lens described above, a metallic material for lens molding is milled to provide many notches on a diffraction grating workface portion. Conventionally, a so called “special R bite” is used to serve that purpose. This special R bite has a curved cutting edge (91) with an acute rake (92) as illustrated in FIG. 6. Rake (92) has a curvature of about 0.5 μm, which provides a drawback in that a notch having a height of about 1 μm is curved half way across the width thereof. Accordingly, highly tilted notches having a narrow pitch therebetween are greatly affected by the presence of a curvature across the notches. To resolve the drawback, the notch height on the center end diffraction grating, which is provided in the center end refracting surface region of the lens, is set to 1-1.5 μm while the notch height of the outer circumferential diffraction grating, which is provided in the outer circumferential refracting surface region, is set to 2 μm or greater. This is because notches are narrower and tilting is larger for the outer circumferential diffraction grating than the center end diffraction grating, necessitating a larger pitch between notches and the use of a diffraction grating of an order higher than the first order.

An increase in the height of notches on the outer circumferential diffraction grating causes a corresponding portion of the lens to stick on the metallic mold during lens molding. This causes chipping, scratches, deformation or contamination thereof, thereby providing poor yield.

First order diffraction beams can be obtained by setting the height of notches on the center end diffraction grating to about 1-1.5 μm and increasing the height of the notches of the outer circumferential diffraction grating. In this case, the outer circumferential diffraction grating produces diffracted beams of a second order or higher, which generates diffracted beams less efficiently than the first order diffracted beams. The theoretical resolution of first or higher order diffracted beams is 100% in terms of geometrical optics. In reality, however, diffracted beams of a second or higher order are likely to waste more diffracted beams than those of first order. For this reason, the use of diffracted beams of the second or higher order for the outer circumferential diffraction grating are likely to provide poorer resolution than those of the first order. Additionally, the use of diffracted beams of the second or higher necessitates an increase in pitch in the outer circumferential diffraction grating. If a tracking servo executes a lens shift on the outer circumferential diffraction grating, uneven distribution of grating grooves causes uneven distribution of coma aberration levels thereon, which induces an erroneous focusing servo. This problem is particularly seen in the form of deteriorated data reproduction performance on fingerprint disks that are contaminated with fingerprints.

If only a small number of diffraction grating is available on the outer circumferential diffraction grating due to a large pitch between notches thereon, and the tracking servo shifts the lens, a different number of diffracted beams become available before and after the lens shift, thereby causing uneven coma aberration intensity distributions thereon. Errors are thus induced in the focusing servo, which is another problem. Particularly, data on fingerprint disks, having fingerprints thereon will not be read with a desired accuracy under the above circumstance.

If a large number of diffraction grating is available on the outer circumferential diffraction grating and a small number of grating is available on the center end diffraction grating, numerical apertures on the CD end cannot be increased. Hence, diffracted beams generated by the center end diffraction grating can be used only for data reproduction on CDs, not data recording thereon.

In view of the previously described problems, the objective of the present invention is to provide a method of molding notches constituting diffraction gratings on the lens surface, a metallic mold for lens formation utilizing the above method of molding notches. It further provides a lens and a method of manufacturing the lens.

### SUMMARY OF THE INVENTION

To overcome the previously described problems, the method of forming notches for lens manufacturing is characterized by a material milled to form a curved surface having many concentric notches utilizing a bite; the bite is of a flat type with rakes having a curvature radius of 0.1 μm or less at both ends of the flat cutting edge thereof; along with the relative rotation of the bite and the material, the material is milled by the flat type bite in a desired shape as the cutting edge of the flat type bite is pressed against the material, wherein the lens is milled by the flat portion of the cutting edge of the flat type bite in such a manner that the curved surface maintains an approximately linear shape; and notches are milled by rakes on the cutting edge of the flat type bite.

The present invention uses the flat type bite used for notch formation that has rakes at two ends of the flat cutting edge bite. Unlike the R bite used for a curved surface with a diffraction grating of conventional technology, the flat type bite provides rakes having a curvature radius of 0.1 μm or less. For this reason, even though pitches are formed by putting a narrow pitch therebetween, there is no need to increase the height of the notches in the outer circumferential region of the lens. This allows the use of (+) or (−) first order diffracted beams without necessitating the use of diffracted beams of a second or higher order. Diffracted beams are thus better utilized. Another advantage of the present invention is the absence of unfavorably tall notches. The present invention provides a method of notch formation where the lens, which is produced by the metallic mold having a diffraction grating workface portion milled, will not fall off from the mold. Hence, the lens is made free from chipping, scratches, deformations, or contaminations and aberrations are stabilized, thereby improving yield in lens production.

Generally, the method of notch formation is used to produce a metallic mold for a lens shaping having a workface on which many notches are formed. In this case, the previously described material to be prepared is a metallic material with which a mold can be produced. Here, many notches are a diffraction grating workface portion which shapes a diffraction grating on the refracting surface of the lens.

Alternatively, the method of forming notches of the present invention further may be used for directly cutting notches onto the lens. In this case, the previously described material to be prepared is a lens material on which many notches are shaped to provide diffraction gratings on the refracting surface thereof.

In the lens of the present invention, it is desirable that the refracting surface of the lens be divided into two regions in a concentric manner wherein the two divisions comprise: a center end refracting surface region and an outer circumferential refracting surface region. It is further desirable that the center end refracting surface region and the outer circumferential refracting surface region each has a different aspheric coefficient and a different optical path function. The notches of a center end diffraction grating on the center end refracting surface region and an outer circumferential diffracting grating on the outer circumferential refracting surface region are given the same height. The refracting surface may be divided into three or more regions but two divisions are simpler for design purposes.

In an optical head apparatus which utilizes the lens of the present invention as a common objective lens, first laser beams are condensed onto the recording surface of a first optical data storage medium, and second laser beams of a different wavelength from the first laser beams are condensed onto the recording surface of a second optical data storage medium being covered by a transparent protective layer that is thinner than the first optical data storage medium. For reproduction of data on the first optical data storage medium utilizing the first laser light source, diffracted beams obtained by the center end refracting surface region is used. For the reproduction of data on the second optical data storage medium utilizing the first laser light source, diffracted beams obtained through both the center end refracting surface region and the outer circumferential refracting surface region are used.

Conventionally, under the method described above, the height of notches constituting the center end diffraction grating, which is provided in the center end refracting surface region, is the numerical value between the first height equal to the phase (2π) of the wavelength of the first laser beams and the second height equal to the phase (2π) of the wavelength of the second laser beams. The height of notches constituting the outer circumferential diffraction grating, which is provided in the outer circumferential refracting surface region, is equal to the phase (2π) of the second laser beams. For example, in this instance all notches constituting the center end diffraction grating and all notches constituting the outer circumferential diffraction grating in the outer circumferential refracting surface region are given the same height. Desirable heights include a numerical value between the first height equal to the phase (2π) of the wavelength of the first laser beams and the second height equal to the phase (2π) of the wavelength of the second laser beams. More preferably, the desired heights include a numerical value close to the second height equal to the phase (2π) of the wavelength of the second laser beams. The problems of conventional technology such as a phase mismatch between the center end and outer circumference are the result of aberrations derived from a difference in the height of notches constituting the center end diffraction grating and the outer circumferential grating. Thus, leveling the notch heights thereof eliminates phase mismatch and suppresses aberrations.

A refracting surface is concentrically divided into the center end refracting surface region and an outer circumferential refracting surface region and each of these regions is provided at its center a diffraction grating and an outer circumferential diffraction grating each of which has notches pointing in opposite directions and emits diffracted beams of opposite polarities in the present invention. In this configuration, even though a change in temperature causes a change in refractive index, a linear expansion of the lens material, or a change in wavelength of laser beams, this configuration protects the center end and the outer end diffraction gratings from adverse effects. As a result, the optical head apparatus in which data on an optical data storage medium is recorded and reproduced by diffracted beams generated by the center end and the outer circumferential diffraction gratings can suppress temperature derived aberrations and maintain good resolution. Thus, excellent pick up property is obtained.

Also, the height of notches of the present invention should be kept at 2 μm or less. Further in the lens of the present invention, emitted diffracted beams should be (+) or (−) first diffracted beams. This configuration makes better use of light than the configuration using (+) or (−) second order diffracted beams.

The border between the center end and the outer circumferential refracting surface regions should be at a point which corresponds to the numerical aperture of the first laser beams. This configuration mitigates aberrations of both first and second laser beams at the center end refracting surface regions; it mitigates aberration for second laser beams at the outer circumferential refracting surface region. Additionally, even though the first laser beams pass though the outer circumferential refracting surface region, those that do not also condense on a focal point of the first laser beams that come from the center end refracting surface region. Compared to the case where the outer circumferential refracting surface region includes the point that corresponds to the numerical aperture of the first laser beams, the above configuration demands much easier designing for the center end and outer circumferential diffraction gratings.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIGS. 1(a), (b), (c), and (d) illustrate the objective lens produced by the notch processing of the present invention wherein (a) is a plan view thereof, (b) is a cross sectional view thereof, (c) is a magnified cross-section of the center end refracting surface region around the optical axis thereof, and (d) is a magnified cross-section of the outer circumferential refracting surface region surrounding the center end refracting surface region.

FIGS. 2(a), (b), and (c) illustrate the lens surface workface on the metallic mold used for producing the objective lens of FIG. 1 where (a) is a plan view thereof, (b) is a cross-sectional view thereof, and (c) is a magnified cross-section thereof.

FIG. 3(a) is a diagram illustrating the shape of the cutting edge of the bite that mills the microscopic notch workface formation during metallic mold manufacturing. FIG. 3(b) is a diagram illustrating the aspheric surface and notches being milled by the bite during milling operation (aspheric surface and notch milling operation).

FIGS. 4(a), (b), and (c) are magnified views of notch formation on a metallic material utilizing the bite of FIG. 2 where (a) is a magnified plan view thereof, (b) is a magnified cross-sectional view thereof, and (c) is a magnified cross-section thereof.

FIGS. 5(a), (b), (c), and (d) illustrate another objective lens produced by notch processing of the present invention where (a) is a plan view thereof, (b) is a cross-sectional view thereof, (c) is a magnified cross-section of the center end refracting surface region around the optical axis thereof, and (d) is a magnified cross-section of the outer circumferential refracting surface region surrounding the center end refracting surface region.

FIG. 6 is a diagram illustrating a bite having a circular cutting edge where one end of the rake is peaked.

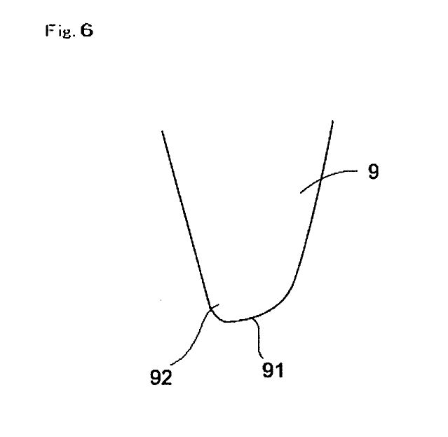

### DETAILED DESCRIPTION OF THE INVENTION

The lens whose refracting surface is provided with a diffraction grating and the method of molding notches for diffraction gratings are described herein with reference to the drawings. More specifically, the method of manufacturing the lens is described below. Embodiment 1

### OBJECTIVE LENS CONFIGURATION

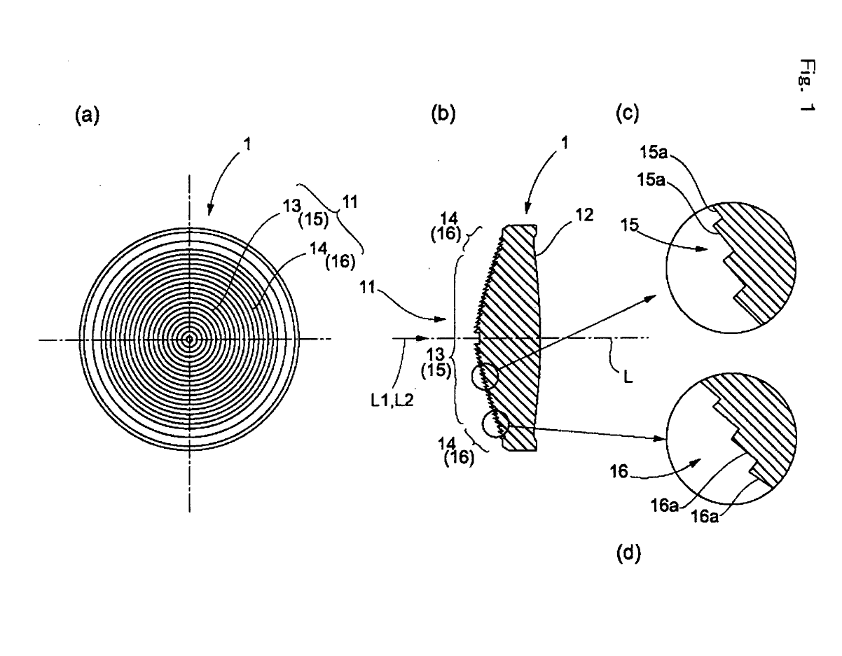

FIG. 1(a), (b), (c), and (d) each is a plan view, a cross-sectional view and a magnified cross-sectional view of the center end refracting surface region around the optical axis, and a magnified cross-sectional view of the outer circumferential refracting surface region which surrounds the center end refracting surface region.

Objective lens (1) illustrated in FIG. 1 is applied to an optical head apparatus which condenses laser beams on CD-Rs and DVDs, which are optical data storage media that have different thicknesses of transparent protective layers or recording densities. First laser beams of 785 nm wavelength record and reproduce data on CD-Rs and second laser beams of 655 nm wavelength record and reproduce data on DVDs.

Objective lens (1) is a convex lens having a refracting surface comprising: an incoming end refracting surface (11) that has positive power incoming first and second laser beams L1 and L2; and outgoing end refracting surface (12) emits laser beams toward an optical data storage medium. Incoming end refracting surface (11) is divided into two regions in a concentric manner wherein the two regions are a center end refracting surface region (13) that inclusively and concentrically surrounds the optical axis L, and an outer circumferential refracting surface region (14) circularly surrounding the outer circumference of center end refracting surface region (13). The border between center end refracting surface region (13) and outer circumferential refracting surface region (14) is at a point that corresponds to a numerical aperture (NA) of 0.45-0.55. Additionally, center end refracting surface region (13) and outer end refracting surface regions (14) each has a different aspheric coefficient and a different optical path function.

Center end diffraction grating (15) is made up of multiple concentric microscopic notches (15a) provided throughout the center end refracting surface region (13). Outer circumferential diffraction grating (16) is made up of multiple concentric microscopic notches (16a) provided throughout the outer circumferential refracting surface region (14).

Objective lens (1) allows first laser beams L1 to pass through center end diffracting surface region (13) through center end diffraction grating (15), which has a property that diffracts first laser beams L1 to form a spot on the recording surface of a CD. Center end diffraction grating (15) provided on center end refracting surface region (13) diffracts second laser beams L2 that pass region through (13) to form a spot on the recording surface of a DVD.

In contrast, outer circumferential diffraction grating (16) provided on outer circumferential refracting surface region (14) diffracts second laser beams L2 that pass region (14) to form a spot on the recording surface of a DVD.

Among first laser beams L1, the component that passes through outer circumferential refracting surface region (14) is a waste component that does not contribute to recording or reproduction of data. In this embodiment, the waste component is diffracted by outer circumferential diffraction grating (16) in such a manner that it does not condense on a point at which a spot of beams is formed on the recording surface of a CD.

During CD data reproduction, in the optical head apparatus having objective lens (1) described above, among all diffracted beam components of first laser beams L1 that pass through center end refracting surface region (13), the only component that is generated by center end diffraction grating (15) forms a spot of beams on the CD recording surface. Ninety percent or a larger component of the beams that pass through center end refracting surface region (13) condense on the CD recording surface as a first order diffracted beams.

In contrast, during DVD data reproduction, a spot of beams of second laser beams L2 is formed on the DVD recording surface by incorporating first and second diffracted beam components thereof where among second laser beams L2 that pass through center end refracting surface region (13), the first diffracted beam component is generated by center end diffraction grating (15) of objective lens (1). Among second laser beams L2 that pass through outer circumferential refracting surface region (14), the second diffracted beam component is generated by outer circumferential diffraction grating (16) objective lens (1). In this case also 90% or a larger component of beams that pass through both the center end refracting surface region (13) and the outer circumferential refracting surface region (14) condenses on the DVD recording surface as first order diffracted beams in the same manner as it condenses on the CD recording surface during CD data reproduction.

In an objective lens (1) thus configured, notches (15a) constituting center end diffraction grating (15) and notches (16a) constituting outer circumferential diffraction grating (16) are shaped as saw teeth in a cross-section pointing toward the same direction.

The height of notch (15a) constituting center end diffraction grating (15) is between the height corresponding to the phase (2π), the wavelength of the second laser beams L2 for DVD data recording and reproduction, and the other height corresponding to the phase (2π); the wavelength of the first laser beams L1 for CD-R data recording and reproduction. In other words, the height (Ha) of notches (15a) of center end diffraction grating (15) is set to 1.23-1.48 μm, for example, which meet the following equation:
h₂<Ha<h₁
h₁=λ₁/(n−1)
h₂=λ₂/(n−2)
where (Ha) is the height of notch (15a); (n) is the refractive index in the center end refracting surface region (13); λ₁ is the wavelength (785 nm) of first laser beams L1; and λ₂ is the wavelength (655 nm) of the second laser beams L2.

It is desired that the height (Ha) of the center end diffraction grating (15) is set to 1.23-1.36 μm, for example, by giving priority to second laser beams L2 for DVDs, to meet the following equation:
h₂<Ha<(h₁+h₂)/2

In contrast, the height of notch (16a) constituting outer circumferential diffraction grating (16) is the same as the notch height of center end diffraction grating (15) provided in the center end refracting surface region (13). The diffracted beams emitted by outer circumferential diffraction grating (16) are of (−) first order. That is, the height (Hb) is set to 1.23-1.36 μm, for example, such that it meets the following equation:
Hb=Ha
Metallic Mold Production Process for Lens Molding

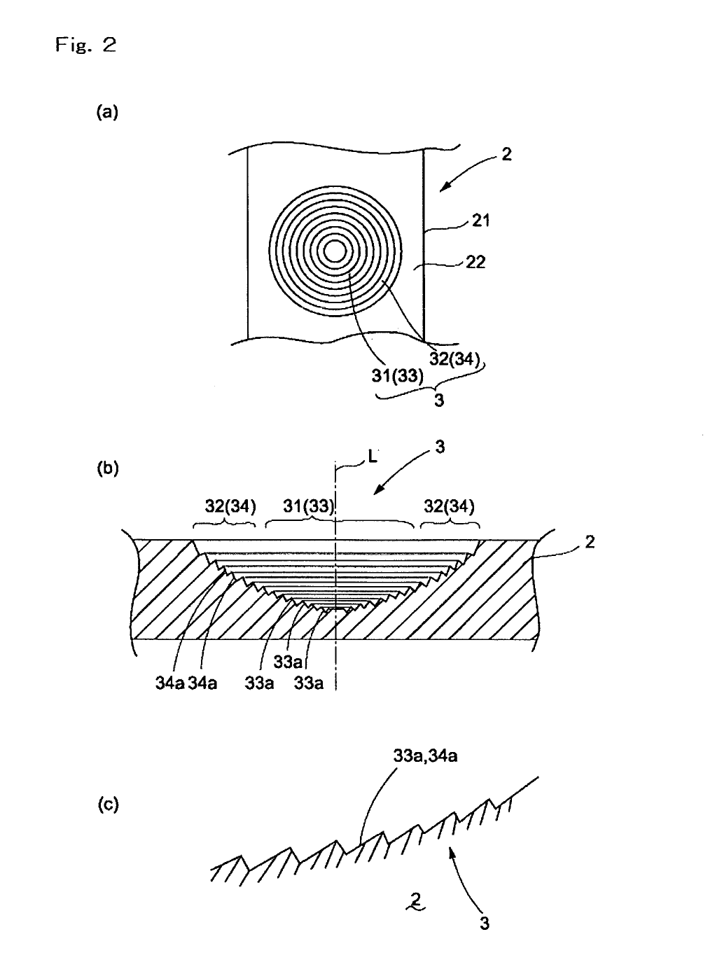

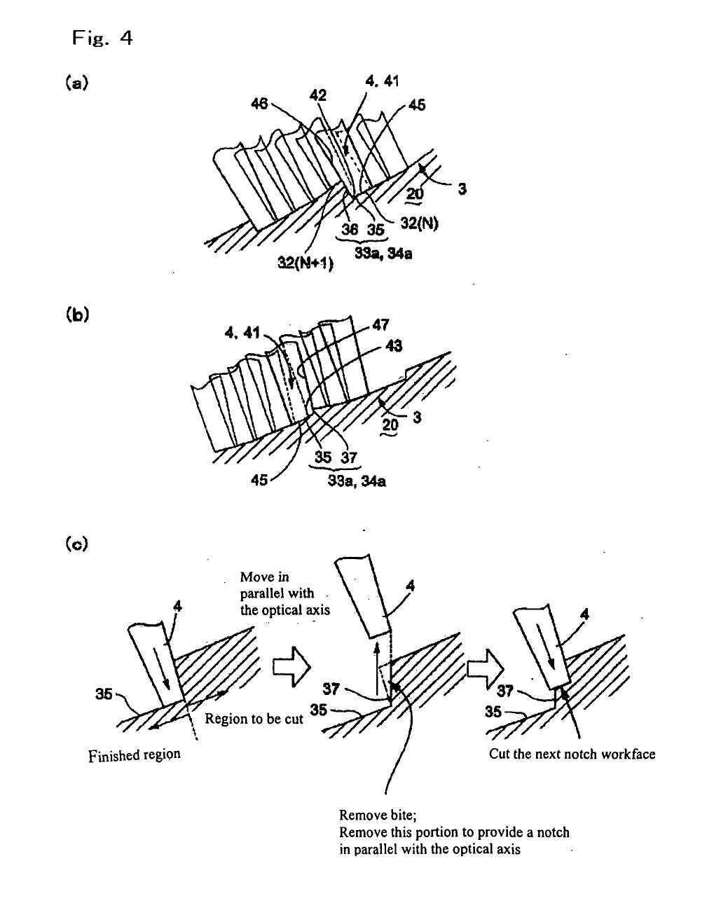

A metallic mold for molding objective lens (1) described above with reference to FIG. 1 is described in detail below by referring to FIGS. 2 and 4.

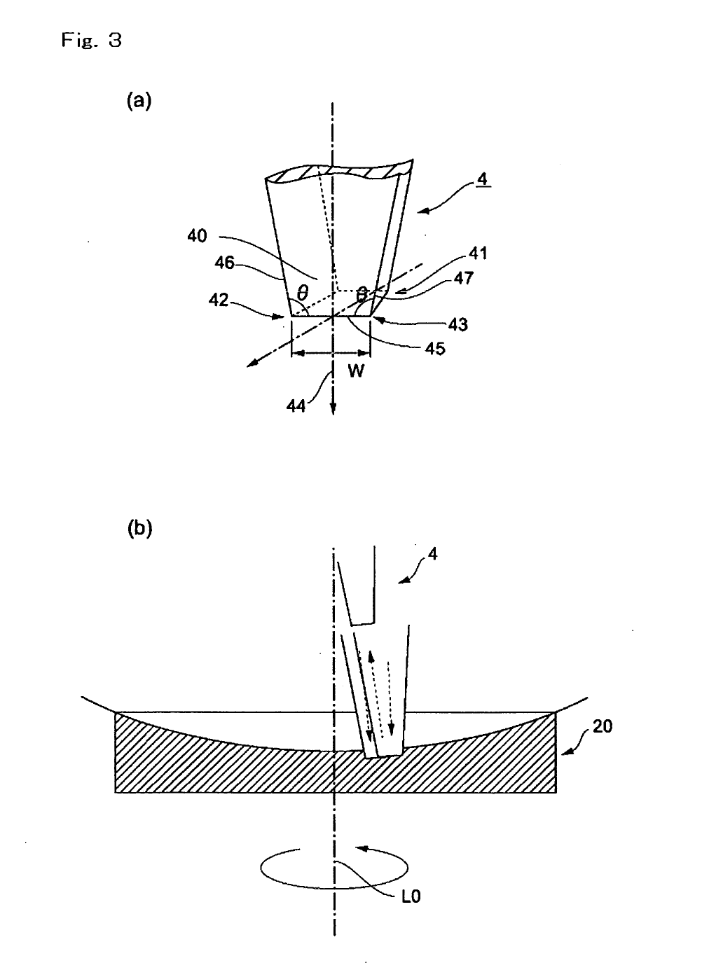

FIG. 2(a), (b), and (c) each is a plan view, a cross-sectional view, and a magnified cross-sectional view of a lens workface of a metallic mold used for molding the objective lens illustrated in FIG. 1, a cross-sectional view of the part, and a magnified cross-sectional view thereof, respectively. FIG. 3(a) is a diagram illustrating the shape of the cutting edge of a cutting tool (hereinafter referred to as “bite”) with which microscopic notches are milled on a metallic mold during production of a metallic mold illustrated in FIG. 2. FIG. 3(b) is a diagram illustrating how cutting aspheric surface and notches are milled (aspheric surface and notch formation operation) utilizing the bite. FIGS. 4(a), (b), and (c) each is a diagram illustrating magnified notches being machined on a metallic material utilizing the bite of FIG. 2.

Metallic mold (2) illustrated in FIG. 2(a), (b) and (c) comprises: a body (21); and notches defined by refracting surface workface (3), which is provided in the center of upper surface (22) of body (21). Refracting surface workface (3) shapes incoming end refracting surface (11) of objective lens (1) and is divided into center end region (31) and outer circumferential regions (32) wherein center region (31) includes the center axis L that corresponds to the optical axis of objective lens (1).

To provide notches (15a) constituting center end diffraction grating (15) in center region (31) of objective lens (1), center end diffraction grating workface portion (33) made up with concentric microscopic notch workface (33a) is formed by the process (notch formation method) described later. To provide notches (16a) constituting outer circumferential diffraction grating (16) in outer circumferential region (32) of objective lens (1), outer circumferential diffraction grating workface portion (34) made up with concentric microscopic notch workface (34a) is formed by the process described later.

In the process of producing metallic mold (2) thus configured, notch workface (33a) and (34a) are formed to provide outer circumferential diffraction grating workfaces (33) and (34) in center region (31) and outer circumferential region (32), respectively. In this process, a flat type bite (4) having a flat cutting edge (41) with rakes (42) and (43) illustrated in FIG. 3(a) is used. This flat type bite (4) comprises: a primary edge (45), which has a given width and linearly extends in a direction perpendicular to milling direction (44) of the bite; and secondary edges (46) and (47), which extend at the both ends thereof at a rake angle θ in a direction horizontal to the milling direction (44). Rake angles θ (42) and (43) in this embodiment are within a range of 90-120 degrees. Cutting edge (41) of flat type bite (4) has a width (W) within a range of 2-20 μm, which is selected in accordance with the radius of curvature of the lens. A large (W) favorably reduces the time required for machining and a small (W) favorably provides a smooth curvature.

Unlike an R bite which has a curved cutting edge, flat type bite (4) of the above configuration has acute rakes (42) and (43) whose curvature radius is less than 0.1 μm.

FIG. 3(a) illustrates a flat type bite (4) held by a lathe for machining. Metallic material 20 to be worked and a flat type bite (4) are held by a lathe (not illustrated) as shown in FIG. 3(b). Metallic material (20) chucked onto the live spindle about the center axis (L0) is turned while flat type bite (4) repeats the cut-and-slide motion to shape the surface of metallic material (20). Notch workface (33a) and (34a) are thus formed thereon in a concentric manner.

More specifically, flat type bite (4) is tilted by a given angle as illustrated in FIG. 4 (a), and presses primary blade (45) at cutting edge (41) of bite (4) against the surface of metallic material (20) to mill metallic material (20) while maintaining the tilted position thereof. Here, metallic material (20) is turned about the center axis (L0) causing cutting edge (40) of flat type bite (4) to slide circumferentially. A strip of annular workface (32 N) having the same width as cutting edge (40) is thus produced during every turn the cutting operation makes. In the same mechanism, an angle created by either rake (42) or rake (43) in the notch portion measures radius of curvature within the range of 0.1 μm. In the example shown in FIG. 4 (a), cutting begins at the outermost circumference of refracting surface workface (3).

After a strip of annular workface (32N) is formed, cutting edge (41) of flat type bite (4) is removed from the surface of metallic material (20), and flat type bite (41) is moved by a distance shorter than width (W) of cutting edge (41) in a direction perpendicular to rake face (40) (inward in the radial direction in this embodiment). Then, rake (42) of cutting edge (41) is pressed against the surface of metallic material (20) to form an aspheric surface or a strip of annular workface (32 N+1) adjacent to the previously formed workface (32 N). As refracting surface workface (3) must have a required curvature through continuous formation of a microscopic linear workface through milling of the adjacent workface. This curvature requirement necessitates a change in tilting of flat type bite (4) every time cutting edge (41) of flat type bite (4) moves by the distance shorter than width (W). The overall shape of linear strips milled one after another by cutting edge (41) of flat type bite (4) provides a required curvature in an approximate sense.

Refracting surface workface (3) having concentric notch workfaces (33a) and (34a) is formed by repeating the above milling operation illustrated in FIG. 2. Notch workfaces (33a) and (34a) have a plane portion (35) (strictly, this is the curvature obtained as a result of continuous formation of a microscopic linear workface), wherein plane portion (35) has two ends. Between the two ends, inner end portion (36) is raised wherein inner end portion (36) of metallic material (20) with respect to the center axis (L0) is turned about the center axis (L0), which is the rotary shaft for metallic material (20) workpiece during milling. In other words, plane portion (35) is milled in an approximately straight line by primary edge (45) of bite (4); end portion (36) is milled by secondary edge (46); and plane portion (35) and inner end (36) is milled at an angle by rake (42) of bite (4).

In this embodiment, the use of flat type bite (4) having rake (42) with a radius of curvature radius of 0.1 μm or less allows notch workfaces (33a) and (34a) to have an acute angle without unfavorably increasing the height of notch workface (34a) at the outer circumference even though notches are formed with tight spacing. Hence, the metallic mold (2) of this embodiment provides an easy way of molding objective lens (1), which is described above with reference to FIG. 1. In this objective lens (1), the absence of unfavorably tall notch workface (34a) at the outer circumference allows beams emitted from center end diffraction grating (15) and outer circumferential diffraction grating (16) to be always a (−) first order diffracted beams. Accordingly, an optical head apparatus utilizing objective lens (1) of this embodiment has no need to use diffracted beams of a second or higher order that wastes beams and deteriorates resolution, thereby ensuring excellent resolution.

According to the present invention, the fact that there is no need for the height of notch workface (34a) at the outer circumference to be increased to eliminate the chance of objective lens (1) to fall from mold (2) when objective lens (1) is molded. This prevents chipping, scratches, deformation, or contamination on the objective lens. The yield of manufacturing objective lens (1) is thus improved.

Embodiment 2

In Embodiment 1, notch workfaces (33a) and (34a) are milled by rake (42) at cutting edge (40) of flat type bite (4). However, notch workfaces (33a) and (34a) may be milled by rake (43) of cutting edge (40) of flat type bite (4) as illustrated in FIG. 4 (b). In this case, between the two edges of plane portion (35), outer end portion (37) with respect to the center axis (L0) is raised wherein outer end portion (37) is turned about the center axis (L0), which is the rotary shaft for metallic material (20) workpiece during milling. As a result, when objective lens (1) is molded utilizing metallic mold (2) of the above configuration, beams emitted by both center end diffraction grating (15) and outer circumferential diffraction grating (16) is (+) first order diffracted beams.

In this embodiment, notches (33a) and (34a) milled by the process illustrated in FIGS. 3 and 4 have an advantage in that, between the two edges of plane portion (35) (this is strictly the curvature obtained as a result of continuous formation of a microscopic linear workface), edge (37), which is raised outside center axis (L0) is milled in parallel with the center axis (L0). In other words, as illustrated in FIG. 4 (c), edge (37) is milled when flat type bite (4) is removed from metallic material (20). By forming objective lens (1) utilizing metallic mold (2) having edge (37) formed parallel with center axis (L0), notches (15a) constituting center end diffraction grating (15) and notches (16a) constituting outer circumferential diffraction grating are raised parallel to the optical axis. Hence, diffracted beams emitted by center end diffraction grating (15) and outer circumferential diffraction grating (16) provide improved efficiency.

Note that as illustrated in FIG. 4(a), between the two ends of plane portion (35), end (36) being raised inside thereof with respect to the center axis (L0) cannot be milled to stay parallel to the center axis (L0) by the milling process illustrated in FIG. 4(c). Particularly, when end (36) of plane portion (35) tilts to a large extent at a point apart from the center axis (L0), it cannot stay parallel to the center axis (L0). In contrast, end (37) can stay in parallel to the center axis (L0).

Embodiment 3

In the present invention, flat type bite (4) having two rakes (42) and (43) are used to form notch workfaces (33a), (34a) during preparation of metallic mold (2). Therefore, one may form notch workface (33a) with rake (42) at cutting edge (40) of flat type bite (4) and notch workface (34a) with rake (43) at cutting edge (40) thereof.

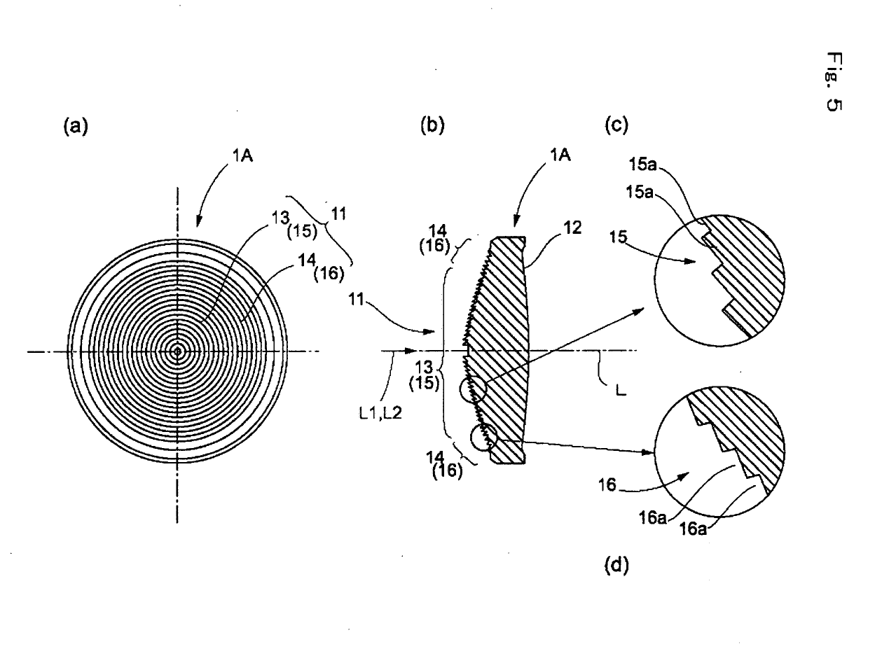

Molding of objective lens (1) utilizing metallic mold (2) thus configured produces objective lens (1A) illustrated in FIGS. 5(a)-(d). Now, objective lens (1A) of Embodiment 3 has a basic configuration which is commonly shared with objective lens (1) of Embodiment 1. Therefore, descriptions of common components are eliminated herein. Note that notch (15a) constituting center end diffraction grating (15) and notch (16a) constituting outer circumferential diffraction grating (16) have notches in the opposite direction. This means that center end diffraction grating (15) emits (−) first order diffracted beams while outer circumferential diffraction grating (16) emits (+) first order diffracted beams.

Even though a change in refractive index or linear expansion occurs in material constituting objective lens (1A) or a change in wavelength occurs in second laser beams (L2) due to a change in temperature, objective lens (1A) previously described can suppress aberrations derived from a change in temperature at center end diffraction grating (15) and outer circumferential diffraction grating (16). In the optical head apparatus of the present invention, a change in surrounding temperature does not change levels of aberrations, as a result, diffracted beams through center end diffraction grating (15) and outer circumferential diffraction grating (16) are picked up accurately during recording and reproduction of data on a DVD.

Production of objective lens (1A) of the above type also utilizes a flat type bite (4) having two rakes (42) and (43) to shape notch workfaces (33a) and (34a) allowing selective use of two rakes (42) and (43). In short, there is no need for switching a bite in the steps comprising the formation of notch workface (33a) and notch workface (34a), which is an efficient milling operation.

Other Embodiments

Embodiments previously described illustrate typical methods of forming notches on metallic mold (2) for molding objective lens (1) or (1A). However, the present invention is applicable to another method in which the surface of lens material constituting objective lens (1) or (1A) is directly milled to form notches. In this case, one may use the substantially similar process of forming notches on metallic mold (2) as the lens manufacturing process. Alternatively, the present invention may be applied to a collimating lens, other than an objective lens.

As previously described, use of the flat type bite having rakes at both ends of the flat cutting edge during notch formation has an advantage in that it allows the diffraction surface to have a radius of curvature of 0.1 μm or less as a result of continuous formation of a linear workface. This is unlike when a special R bite is used for the conventional formation of a curved diffraction grating. In other words, notch workfaces have an acute angle at the outer circumference or the like even though they are formed by putting a narrow pitch therebetween. This is accomplished without increasing the height of the notch workface more than necessary. The absence of a need for diffracted beams of the second or higher orders provides excellent resolution. Another advantage of the present invention is that the curvature of the lens surface is created in such a manner that it provides approximately a linear surface without unfavorably increasing the height of the notches. Further, there is no circumstance that causes an objective lens to fall off from the metallic mold as long as diffraction grating workface is shaped on the metallic mold by the notch formation process of the present invention. Accordingly, chipping, scratches, deformation, or contamination of the objective lens is thus prevented, thereby improving yield.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A method of shaping notches for lens manufacturing characterized in that a material is milled to form a curved surface having many concentric notches utilizing a bite; the bite is of a flat type with rakes having a radius of curvature of 0.1 μm or less at both ends of the flat cutting edge; the relative rotation of the bite and the material allowing the flat type bite to mill the material in a desired shape as the cutting edge of the flat type bite is pressed against the material, wherein the lens is milled by the flat portion along the cutting edge of the flat type bite in such a manner that the curved surface maintains an approximately linear shape; wherein the notches are milled by the rakes on the cutting edge of the flat type bite.

2. A metallic mold for lens molding having many notches on the lens workface wherein a metallic mold material for lens shaping is milled to provide many concentric notches thereon with a bite; relative rotation of the bite and the material allows the flat type bite with rakes to mill the material in a desired shape as the cutting edge of the flat type bite is pressed against the material; wherein the lens is milled by the flat portion along the cutting edge of the flat type bite in such a manner that the curved surface maintains an approximately linear shape; the notches being milled by the rakes on the cutting edge of the flat type bite; the many notches providing a diffraction grating workface portion required for molding diffraction gratings on the refracting surface of a lens.

3. A lens molded by the metallic mold according to claim 2.

4. A method of manufacturing a lens having a curvature on which many concentric notches are provided by milling a lens material with a bite; relative rotation of the bite and the material allows the flat type bite with rakes to mill the material in a desired shape as the cutting edge of the flat type bite is pressed against the material; wherein the lens is milled by the flat portion along the cutting edge of the flat type bite in such a manner that the curved surface maintains an approximately linear shape; the notches being milled by the rakes on the cutting edge of the flat type bite; the notches providing a diffraction grating workface portion required for molding diffraction gratings on the refracting surface of the lens.

5. A lens having a surface with a curvature on which many concentric notches are provided; the curvature being milled approximately in a linear shape with a flat portion along a cutting edge of a flat type bite with rakes the notches milled by the rakes on the cutting edge of the flat type bite; the notches providing a diffraction grating on a refracting surface.

6. The lens according to claim 5, wherein the refracting surface is concentrically divided into a center end refracting surface region and an outer circumferential refracting surface region that includes the center end refracting surface region and the outer circumferential refracting surface region each having a center and an outer end diffraction grating; wherein each of the gratings is constructed with many notches having an identical height, a different aspheric coefficient, and a different optical path function.

7. The lens according to claim 5, wherein the refracting surface is concentrically divided into a center end refracting surface region and an outer circumferential refracting surface region that includes the center end refracting surface region and the outer circumferential refracting surface region each having a center end diffraction grating and an outer end diffraction grating wherein the notches on the center end and the outer circumferential diffraction gratings are formed in different directions, thereby emitting beams of an order with different polarities.

8. The lens according to claim 5, wherein the height of all of the notches is at most 2 μm.

9. The lens according to claim 5, wherein the emitted diffracted beams are (+) or (−) first order beams.

10. A method of shaping notches for use in lens manufacturing, the method comprising the steps of:
providing a material to be milled to form a curved surface having many concentric notches utilizing a bite;
providing the bite of a flat type with rakes having a curvature radius of at most 0.1 μm at both ends of the flat cutting edge; and
milling the material with the flat type bite in a desired shape as the cutting edge of the flat type bite is pressed against the material and while the flat type bite rotates with respect to the material;
wherein the lens is milled by the flat portion along the cutting edge of the flat type bite in such a manner that the curved surface maintains an approximately linear shape and the notches are milled by the rakes on the cutting edge of the flat type bite.

11. A metallic mold for lens molding having many notches on the lens workface comprising:
a metallic mold material for lens shaping is milled to provide many concentric notches thereon with a bite; and
a relative rotation of the bite and the material allows the flat type bite with rakes to mill the material in a desired shape as the cutting edge of the flat type bite is pressed against the material;
wherein the lens is milled by the flat portion along the cutting edge of the flat type bite in such a manner that the curved surface maintains an approximately linear shape and the notches are milled by the rakes on the cutting edge of the flat type bite, where the many notches provide a diffraction grating workface portion required for molding diffraction gratings on the refracting surface of the lens.

12. A lens molded by the metallic mold according to claim 11.

13. A method of manufacturing a lens having a curvature on which many concentric notches are provided, the method comprising:
providing a lens material to be milled to form a curved surface having many concentric notches utilizing a bite; and
milling the material with the flat type bite with rakes in a desired shape as the cutting edge of the flat type bite is pressed against the material and while the flat type bite rotates with respect to the material;
wherein the lens is milled by the flat portion along the cutting edge of the flat type bite in such a manner that the curved surface maintains an approximately linear shape and the notches are milled by the rakes on the cutting edge of the flat type bite, where the notches provide a diffraction grating workface portion required for molding diffraction gratings on the refracting surface of the lens.

14. A lens having a surface with a curvature on which many concentric notches are provided comprising:
the curvature being milled approximately in a linear shape with a flat portion along a cutting edge of a flat type bite with rakes; and
the notches being milled by the rakes on the cutting edge of the flat type bite;
wherein the notches provide a diffraction grating on a refracting surface.

15. The lens according to claim 14, wherein the refracting surface is concentrically divided into a center end refracting surface region and an outer circumferential refracting surface region that includes the center end refracting surface region and the outer circumferential refracting surface region each having a center and an outer end diffraction grating, wherein each of the gratings is constructed with many notches having an identical height, a different aspheric coefficient, and a different optical path function.

16. The lens according to claim 14, wherein the refracting surface is concentrically divided into a center end refracting surface region and an outer circumferential refracting surface region that includes the center end refracting surface region and the outer circumferential refracting surface region each having a center end diffraction grating and an outer end diffraction grating, wherein the notches on the center end and the outer circumferential diffraction gratings are formed in different directions, thereby emitting beams of an order with different polarities.

17. The lens according to claim 14, wherein the height of all of the notches is at most 2 μm.

18. The lens according to claim 14, wherein the emitted diffracted beams are (+) or (−) first order beams.
